(19) United States
(12) Patent Application Publication
(10) Pub. No.: US 2008/0164652 A1
(43) Pub. Date: Jul. 10, 2008

(54) FEED ROLLER, MANUFACTURING METHOD OF FEED DRIVE ROLLER, RECORDING APPARATUS

(75) Inventor: Koichi OTSUKI, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/971,713

(22) Filed: Jan. 9, 2008

(30) Foreign Application Priority Data
Jan. 10, 2007 (JP) 2007-002359

(51) Int. Cl. B65H 5/06; B29C 45/00; B41J 13/036; B29C 71/00

(52) U.S. Cl. 271/272; 264/129; 347/4

(57) ABSTRACT

There is provided a feed roller that includes a feed drive roller and a teeth roller drivenly rotated by making contact with the feed drive roller, wherein the circumferential surface of the feed drive roller is equipped with a groove with which a part of the teeth roller makes contact.

### BACKGROUND

1. Technical Field

The present invention relates to a feed roller equipped with a feed drive roller and a teeth roller making contact with the feed drive roller to be drivenly rotated, a manufacturing method of the feed drive roller which is a constituent member of the feed roller, and a recording apparatus or a liquid ejecting apparatus in which the feed roller is applied to a roller for discharging a material to be recorded or a material on which a liquid is ejected.

Herein, the liquid ejecting apparatus denotes an apparatus such as an ink jet type recording apparatus in which a liquid such as an ink is ejected (jetted) from the head to perform recording (adhere the liquid) on a material on which a liquid is ejected such as a material to be recorded.

Further, the liquid ejecting apparatus is not limited to a recording apparatus such as a printer, a plotter, a copier, and a facsimile in which an ink jet type recording head is used and for ejecting an ink from the recording head to perform recording on a material to be recorded, and an apparatus for ejecting a liquid corresponding to the application instead of the ink from a liquid ejecting unit corresponding to the recording head on a material on which a liquid is ejected corresponding to the material to be recorded is included.

Note that as for the liquid ejecting head, besides the recording head, there are included a color material ejecting head used for manufacture of a color filter such as a liquid crystal display, an electrode material (conductive paste) ejecting head used for manufacture of an electrode such as an organic EL display or a field emission display (FED), a bioorganic material ejecting head used for manufacture of a biochip, a sample ejecting head as a minute pipette, and the like.

2. Related Art

Hereinafter, description will be made by employing an ink jet printer which is an example of a liquid ejecting apparatus and a recording apparatus. The ink jet type printer is equipped with a discharge roller for discharging a paper after recorded to the outside portion. The discharge roller is equipped with a discharge drive roller and a teeth roller making contact with the discharge drive roller to be drivenly rotated. Among them, the discharge drive roller is equipped with a roller main body which becomes a core material and a synthetic rubber tube for covering the circumferential surface of the roller main body. The circumferential surface of the discharge drive roller covered by the synthetic rubber tube has been formed in a smooth cylinder shape having no irregularity.

Further, in such a discharge roller, in order to safely and surely feed and discharge a paper, in many case, the teeth roller is pressed against the discharge drive roller, as an example, at a large pressing force about 0.343N (35 gf). Accordingly, there is a fear in that the circumferential surface of the discharge drive roller is scraped by a teeth roller to be scratched, and this may reduces the accuracy of paper feeding, and a desired feeding force (discharge force) can not be obtained by the irregularity of the surface on which the one scraped by the teeth roller is adhered again at a nearby site.

Further, the synthesis rubber suffers large alteration by heat (has a large thermal expansion rate), so that fluctuation occurs in the size accuracy of the outer diameter of the discharge drive roller. Then, the fluctuation of the size accuracy of the outer diameter of the discharge drive roller causes skew (inclination) of a paper to cause deterioration of recording quality when high speed paper feeding (discharging) for high speed printing is performed.

On the other hand, forming of the circumferential surface of the discharge drive roller with a material having excellent property in abrasion resistance such as a ceramic prevents occurrence of scratch and irregularity of the circumferential surface of the discharge drive roller. However, at this case, the teeth roller formed by a metal becomes worn, similarly causing adverse influence in recording quality.

Further, it is possible that the roller main body and the teeth roller become always in non contact state by preliminarily forming a groove having an angular groove shape on the circumferential surface of the roller main body as shown in JP-A-9-86749. Herewith, the problem that the circumferential surface of the discharge drive roller is scraped by the teeth roller to be scratched can be prevented. However, the teeth roller is held in an unstable state in which the teeth roller is pivotally supported by a shaft member such as a bar spring having elastic deformation properties in order to obtain the desired pressing force.

Accordingly, in the state where the teeth roller does not receive any restraint from the discharge drive roller, the teeth roller may freely move in the axis direction or incline. As a result, there is a problem in that the accuracy of paper feeding may be destabilized and the recording surface of the paper may be scratched due to occurrence of displacement or occurrence of skew (inclination) in paper feeding caused by the movement or inclination when the top end of the paper is entered in the discharge roller. Further, when the bottom end of the paper is disengaged from the discharge roller, there is also a similar problem due to the movement and inclination of the teeth roller.

### SUMMARY

An advantage of some aspects of the invention is that it provides a feed roller which prevents movement or inclination of a teeth roller to stabilize the feeding accuracy of a material to be fed and to prevent that the material to be fed is scratched when the material to be fed is entered to the reed roller or when disengaged from the feed roller by restraining the movement of the teeth roller in the axis direction. In addition, another advantage of some aspects of the invention is that it provides a manufacturing method of the feed drive roller which is a constituent member of the feed roller, and a recording apparatus and a liquid ejecting apparatus in which the feed roller is applied to a discharge roller for a material to be recorded or a material on which a liquid is ejected.

According to a first aspect of the invention, there is provided a feed roller including a feed drive roller and a teeth roller drivenly rotated by making contact with the feed drive roller. The circumferential surface of the feed drive roller is equipped with a groove with which a part of the teeth roller makes contact.

According to the first aspect of the invention, the circumferential surface of the feed drive roller is equipped with a groove which makes contact with a part of the teeth roller, accordingly, the movement of the teeth roller in the axis direction is restrained by the contact and the movement and inclination of the teeth roller is prevented when a material to be fed is entered in the fees roller or when disengaged from the fees roller. Herewith, the feeding accuracy of a material to be fed can be stabilized and that a material to be fed is scratched can be prevented.

Further, the teeth roller does not make contact with the circumferential surface of the feed drive roller and makes contact with the inside of the groove. Accordingly, even when the contact portion is scratched in some degree, the scratch does not influence to the feeding accuracy of a material to be fed. In addition, the pressing force of the teeth roller to the feed drive roller becomes week corresponding to the depth of the groove, so that the groove becomes difficult to be scratched for the depth. Further, in the state where a material to be fed is present between the both rollers and the material to be fed is fed, the teeth roller is pushed back toward the outside direction of the groove by the rigidity of the paper to be fed, so that the feeding force having a set magnitude is automatically obtained.

According to a second aspect of the invention, there is provided a feed roller in which the feed drive roller is equipped with a roller main body having the groove on the circumferential surface and a surface layer for covering the roller main body so that the groove appears on the circumferential surface in the first aspect.

According to the second aspect of the invention, a hard material easy for forming and superior in mechanical strength can be applied and a soft material having a large frictional force and superior in grip property can be applied. Further, a groove is formed also on the circumferential surface of the surface layer, so that stability of the feeding accuracy of the material to be fed can be provided and that a material to be fed is scratched can be prevented.

According to a third aspect of the invention, there is provided a feed roller in which the surface layer is a flexible synthetic resin material in the second aspect.

According to the third aspect of the invention, the grip force corresponding to a synthetic rubber can be provided by a synthetic resin material which can be easily shaped.

According to a fourth aspect of the invention, there is provided a feed roller in which the synthetic resin material is applied by spray in the third aspect.

According to the fourth aspect of the invention, shaping of the synthetic resin material and fixing the synthetic resin material to the feed drive roller can be performed by a single process, so that the number of assembling processes can be reduced. Further, by evenly applying the synthetic resin material and by selecting a synthetic resin material having a small thermal expansion rate, it becomes possible to improve the outer diameter size accuracy of the feed roller.

According to a fifth aspect of the invention, there is provided a feed roller in which the synthetic resin material is a water type polyurethane resin material in the third or fourth aspect.

According to the fifth fourth aspect of the invention, a water type polyurethane resin material is used as a material of the surface layer. Accordingly, a grip force larger than that of a synthetic rubber can be obtained without adding any wear resistance particles or the like. Further, a problem about environment contamination does not occur as no organic solvent is included.

According to a sixth aspect of the invention, there is provided a feed roller in which not less than two teeth of teeth of the teeth roller are entered in and made contact with the groove in the state where no material to be fed is present between the feed drive roller and the teeth roller in any one of the first to fifth aspects.

According to the sixth aspect of the invention, the number of the contact positions of the teeth roller and the groove becomes plural, so that the rotation caused by displacement of the teeth roller can be surely prevented, binding force to the teeth roller can be improved, and further improvement of the feeding accuracy can be provided.

According to a seventh aspect of the invention, there is provided a feed roller in which the teeth roller is pivotally supported by a bar spring bridged in the direction crossing a feeding direction of a material to be fed in any one of the first to sixth aspects.

According to the seventh aspect of the invention, the application of the structure in which the teeth roller is pivotally supported by the bar spring increases the effect.

According to an eighth aspect of the invention, there is provided a feed roller in which the cross sectional shape of the groove is a V character groove shape in any one of the first to seventh aspects.

According to the eighth aspect of the invention, the tooth of the teeth roller positioned at the lower side is to be made contact with a portion of the groove near the bottom whose width size is narrow. Accordingly, the posture of the teeth roller is further stabilized and improvement of the feeding accuracy of the feed roller can be provided.

According to a ninth aspect of the invention, there is provided a feed roller in which the width size of the groove is set so that the outside surface of the teeth roller is made contact with the inside surface of the groove in any one of the first to eighth aspects.

According to the ninth aspect of the invention, the feeding accuracy of the feed roller can be further improved by increasing the binding force of the teeth roller without needlessly increasing the pressing force of the teeth roller to the feed drive roller.

According to a tenth aspect of the invention, there is provided a feed roller in which the distal end of the teeth roller does not make contact with the circumferential surface of the feed drive roller in the ninth aspect.

According to the tenth aspect of the invention, the feeding accuracy of the feed roller can be still further improved by increasing the binding force of the teeth roller without needlessly increasing the pressing force of the teeth roller to the feed drive roller with the non contact structure.

According to an eleventh aspect of the invention, there is provided a manufacturing method of a feed drive roller including forming a roller main body having a groove receiving a part of a teeth roller and making contact with a part of the teeth roller on the circumferential surface by injecting a plastic material into a mold and forming a surface layer by spraying a synthesis resin coating material on the circumferential surface of the formed roller main body for application and by hardening the synthesis resin coating material.

According to the eleventh aspect of the invention, the feed drive roller can be manufactured by only the two processes of the roller main body forming process and the surface layer forming process, so that the productivity can be improved by reducing the number of the processes. Further, by employing the spray application method, an even surface layer can be formed, and the accuracy of the outer diameter size of the feed drive roller can be improved by selecting a synthetic resin coating material having a small thermal expansion rate.

According to a twelfth aspect of the invention, there is provided a recording apparatus including a recording unit for performing recording by ejecting an ink from a recording head in the state where a material to be recorded is supported by a platen and a discharge roller for discharging a material to be recorded on which record is performed to the outside. The discharge roller is equipped with a discharge drive roller and a teeth roller drivenly rotated by making contact with the discharge drive roller, and the circumferential surface of the discharge drive roller is equipped with a groove with which at least a part of the teeth roller makes contact.

According to the twelfth aspect of the invention, the movement of the teeth roller in the axis direction is restrained. Accordingly, the stabilization of the discharge accuracy when a material to be recorded is entered to the discharge roller and when disengaged from the discharge roller can be provided, and that a material to be recorded is scratched or the like can be prevented.

According to a thirteenth aspect of the invention, there is provided a liquid ejecting apparatus including a liquid ejecting unit for performing liquid ejection by ejecting a liquid from a liquid ejecting unit in the state where a material on which a liquid is ejected is supported by a supporting unit and a discharge roller for discharging a material on which a liquid is ejected on which liquid ejection is performed to the outside. The discharge roller is equipped with a discharge drive roller and a teeth roller drivenly rotated by making contact with the discharge drive roller, and the circumferential surface of the discharge drive roller is equipped with a groove with which at least a part of the teeth roller makes contact.

According to the thirteenth aspect of the invention, the movement of the teeth roller in the axis direction is restrained. Accordingly, the stabilization of the discharge accuracy when a material on which a liquid is ejected is entered to the discharge roller and when disengaged from the discharge roller can be provided. Further, that a material on which a liquid is ejected is scratched or the like can be prevented.

### BRIEF DESCRIPTION OF THE DRAWINGS

The invention will be described with reference to the accompanying drawings, wherein like numbers reference like elements.

FIG. 1 is a side cross sectional view specifically showing an inner structure of an ink jet printer.

FIG. 2 is a front view showing a using mode of a feed roller.

FIG. 3A is a front cross sectional view showing the feed roller when a material to be fed is not pinched and FIG. 3B is a side cross sectional view showing the feed roller when a material to be fed is not pinched.

FIG. 4A is a front cross sectional view showing the feed roller when a material to be fed is pinched and FIG. 4B is a side cross sectional view showing the feed roller when a material to be fed is pinched.

FIGS. 5A to 5C are each a side cross sectional view showing an operation of the feed roller when a material to be fed is entered.

FIGS. 6A to 6C are each a side cross sectional view showing an operation of the feed roller when the material to be fed is exited.

FIGS. 7A to 7C are each a front cross sectional view showing a manufacturing process of the feed drive roller.

FIGS. 8A to 8D are each a front cross sectional view showing another manufacturing process of the feed drive roller.

FIGS. 9A to 9D are front cross sectional views showing various aspects of the cross sectional shape of a groove.

FIGS. 10A and 10B are front cross sectional views showing two types of contact positions of a teeth roller and the groove.

### DESCRIPTION OF EXEMPLARY EMBODIMENTS

Hereinafter, a feed roller, a method of manufacturing a feed drive roller which is a constituent member of the feed roller, and a liquid ejecting apparatus in which the feed roller is applied to a discharge roller according to the invention will be described. First, an ink jet printer 100 is employed as a best mode for carrying out a liquid ejecting apparatus and a recording apparatus which is an example thereof of the invention, and the whole structure will be schematically described based on the accompanying drawings.

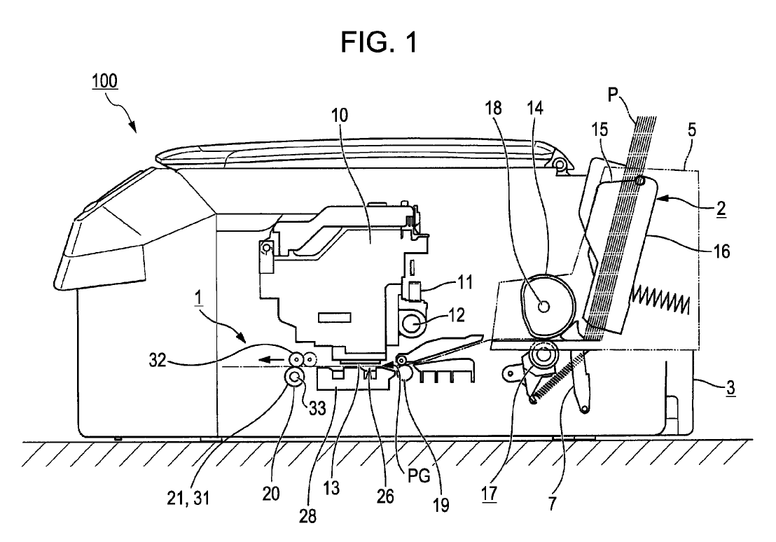

FIG. 1 is a side cross sectional view schematically showing an inner structure of the ink jet printer. The ink jet printer 100 shown in FIG. 1 is equipped with a printer main body 3 which is an example of a liquid ejecting apparatus main body or a recording apparatus main body, and equipped with an automatic feeding device 2 at the side of the rear portion and at the upper portion of the printer main body 3. The automatic feeding device 2 is a device capable of automatically and continuously feeding a material to be recorded (hereinafter, also referred to as a paper) P which is an example of a material to be fed and a material on which a liquid is ejected one by one.

The automatic feeding device 2 is equipped with a feed tray 5 on which a plurality of papers P can be placed in a laminated manner, a hopper 16 for pushing up the papers P laminated on the feed tray 5 toward a feed roller 14, the feed roller 14 for picking up the upper papers P on the feed tray 5 in cooperation with the hopper 16 (feeding operation by pinching and pressing), and a retard roller 17 which is an example of separating means for separating the topmost paper P used for recording from the following papers P among the multi-fed plurality of papers P.

Further, an edge guide 15 for guiding a paper P in a sub scanning direction which becomes the feeding direction and the transporting direction of the paper P by making contact with the right and left edges of the paper P is provided to the paper feed tray 5. The hopper 16 is slidably provided centering around a slide support provided in the upper direction and a rotation axis 18 of the feed roller 14 is configured so as to be able to move up and down in conjunction with the rotation. The retard roller 17 is a circular member when viewed from the side and has a diameter smaller than that of the feed roller 14. A cover member formed by a synthetic rubber or the like is attached on the circumferential surface of the retard roller 17. Further, a damper mechanism not shown is connected to the rotation axis of the retard roller 17 and the retard roller 17 is configured so as to be able to be rotated with a load resistance from the damper mechanism.

A feed roller 19 constituted by a pair of upper and lower nip rollers is provided at the downstream of the feed roller 14 in the paper feeding direction. The paper P fed by the feed roller 19 is to be guided to a recording position 26 which is an example of a liquid ejecting position. A recording head 13 which is an example of a liquid ejecting unit for ejecting an ink which is an example of a liquid on a paper P to directly execute recording is positioned in the upper direction of the recording position 26. A platen 28 for supporting the lower surface of a paper P is provided in the lower direction of the recording position 26. Note that, the platen 28 plays a role to define a gap GP between with the recording head 13 which significantly relates to the recording quality and constitute a recording executing unit which is an example of a liquid ejecting executing unit with the recording head 13.

The recording head 13 is mounted on the lower surface of a carriage 10 that reciprocates in a main scanning direction perpendicular to the sub scanning direction. The recording head 13 is guided by a carriage guide shaft 12 bridged in the main scanning direction and configured so as to be able to be reciprocated by receiving a drive force from an endless belt 11 strained similarly in the main scanning direction. Further, a discharge roller 20 constituted by a pair of nip rollers similarly to the feed roller 19 is provided at the downstream of the recording position 26 in the paper feeding direction. Then, the paper P discharged by the discharge roller 20 is to be discharged to be laminated on the placement surface of a discharge stacker which is an example of a receiving unit for a material on which a liquid is ejected not shown. Note that the discharge roller 20 is an aspect of the feed roller 1 of the invention described below in detail.

### Embodiment

Next, the feed roller 1 of the invention applicable as the discharge roller 20 of the ink jet printer 100 constituted in such a manner will be concretely described based on the accompanying drawings.

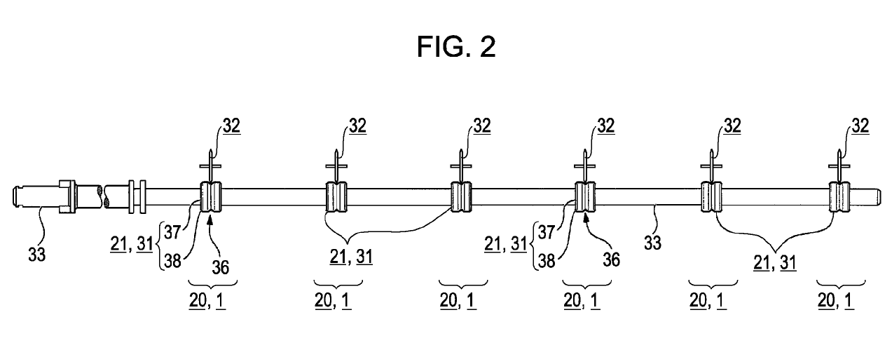

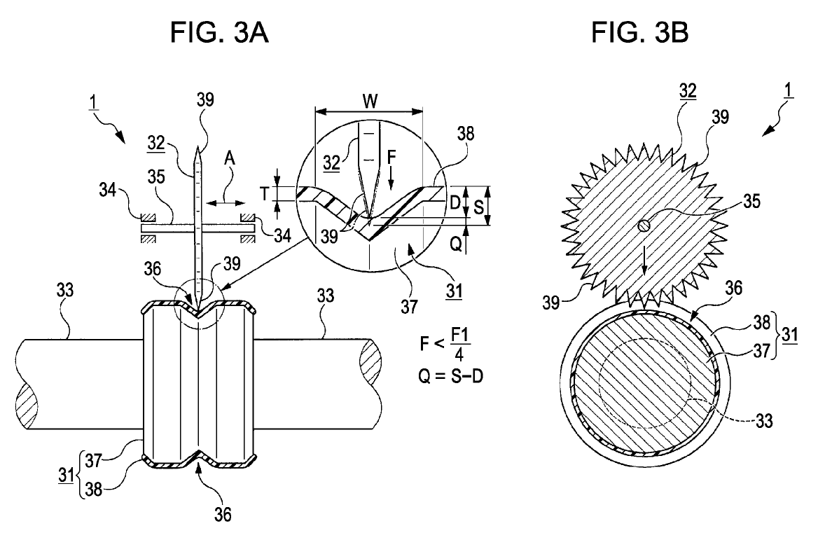

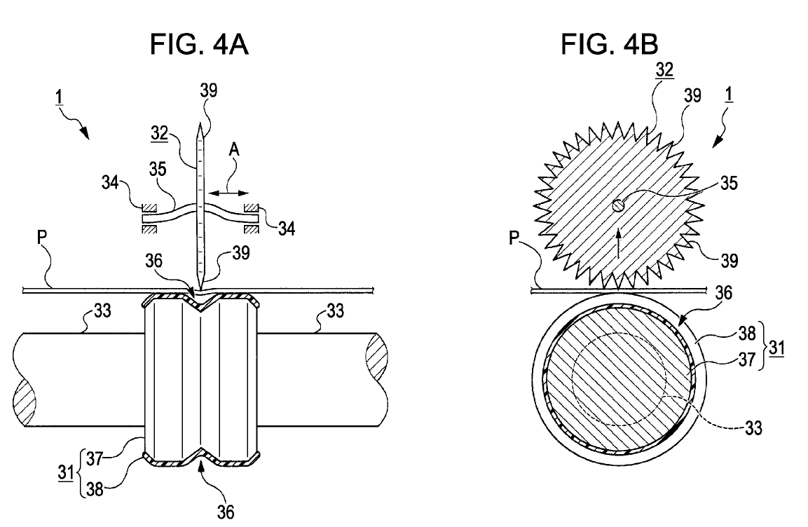

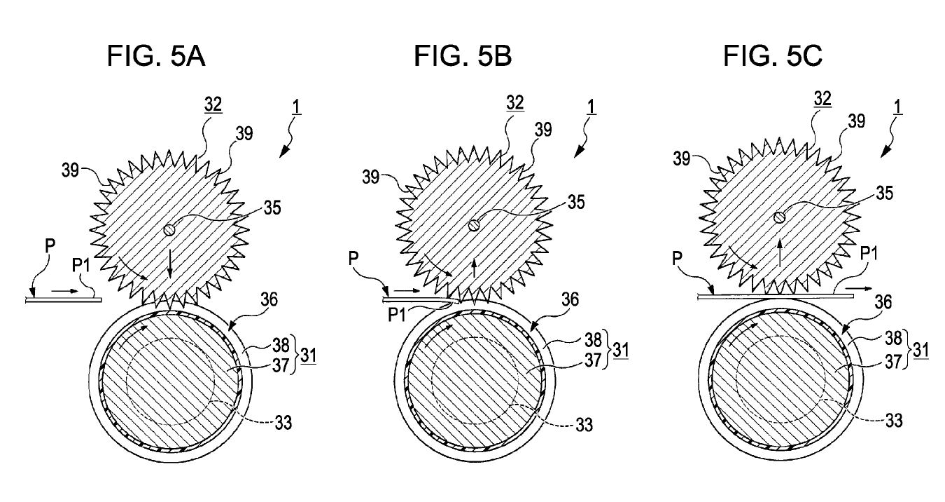

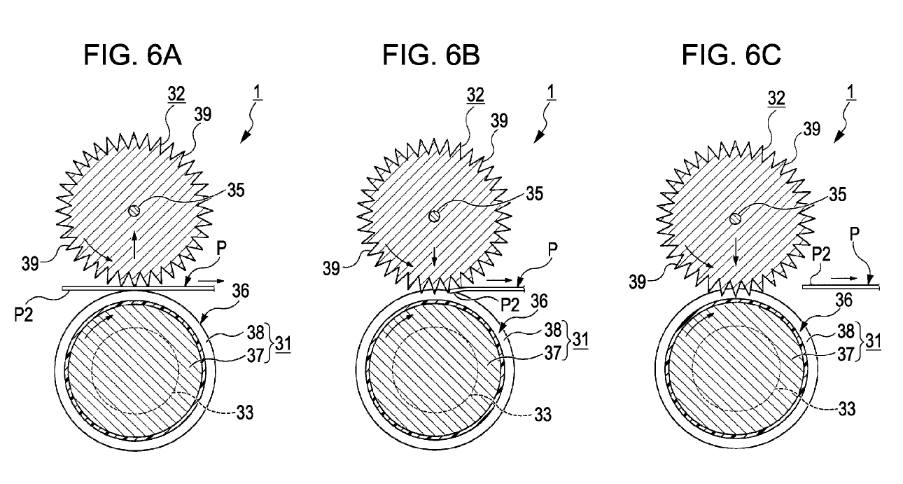

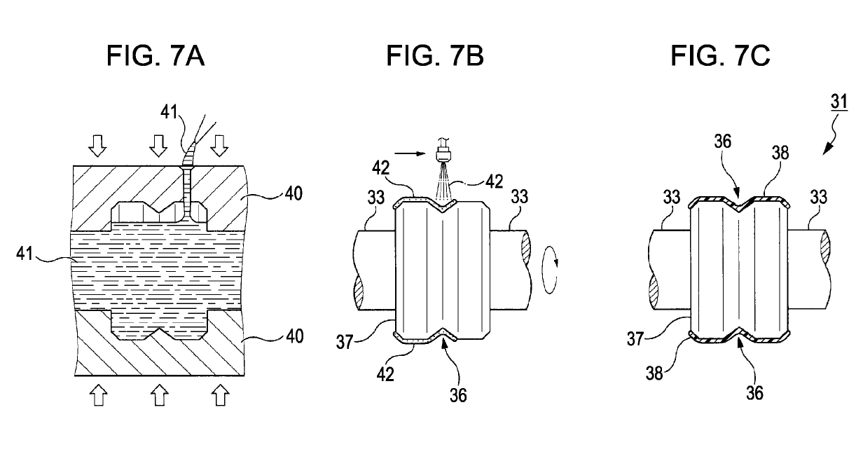

FIG. 2 is a front view showing a using aspect when a plurality pairs of feed roller is disposed in the axis direction with an appropriate distance, FIG. 3A is an enlarged front cross sectional view and FIG. 3B is an enlarged side cross sectional view showing a pair of feed roller in the state where there is no material to be fed between a feed drive roller and a teeth roller. Further, FIG. 4A is an enlarged front cross sectional view and FIG. 4B is an enlarged side cross sectional view showing the pair of feed roller in the state where there is a material to be fed between the feed drive roller and the teeth roller. FIGS. 5A to 5C are side cross sectional views showing the operation of the feed roller in a phased manner when a material to be fed is entered, and FIGS. 6A to 6C are side cross sectional views showing the operation of the feed roller in a phased manner when a material to be fed is disengaged from the feed roller (when the material to be fed is discharged). Further, FIGS. 7A to 7C are front cross sectional views showing the manufacturing process of the feed drive roller in a phased manner.

### A: Structure of Feed Roller

The feed roller 1 of the invention is constituted by a feed drive roller 31 (discharge drive roller 21 when the feed roller 1 is the discharge roller 20) positioned, as an example, in the lower direction and a teeth roller 32 for making contact with the feed drive roller 31 to be drivenly rotated positioned, as an example, in the upper direction. Then, as shown in FIG. 2, as an example, six pairs of such a feed rollers 1 are provided in the embodiment, and the feed rollers 1 are provided so as to align in the axis direction A along the rotation shaft 33 with appropriate spaces.

The feed roller 31 is constituted by a roller main body 37 having a groove 36 formed on the circumferential surface and a surface layer 38 covering the roller main body 37 in the state where the groove 36 appears on the circumferential surface. Then, six roller main bodies 37 are provided as described above. The six roller main bodies 37 are formed by a plastic material 41 with the rotation shaft 33 and the roller main bodies 37 and the rotation shaft 33 are integrally formed by injection molding as described below. Further, the groove 36 is formed to receive a part of the teeth roller 31 on the circumferential surface of the feed drive roller 31 on which the surface layer 38 is formed and make contact with a part of the teeth roller 32.

Specifically, not less than two teeth of the teeth 39 of the teeth roller 31 is to be entered to and engaged with the groove 36 in the state where no material P to be fed exists between the feed drive roller 31 and the teeth roller 32. Incidentally, a plurality positions at which the teeth roller 32 and the groove 36 contact each other exist by the structure, so that a tooth is in the contact state even when another tooth is in non contact state and displacement and rotation of the teeth roller 32 is prevented by the restraint based on the contact, and improvement of feeding accuracy can be provided. Further, in the embodiment, the cross sectional shape of the groove 36 is formed to be a V character groove shape, so that the movement of the teeth roller 32 in the axis direction is to be restrained as the teeth roller 32 comes close to the bottom of the groove 36.

Then, in the embodiment, the width W of the groove 36 at the outer circumferential side is set to about 2 mm, the depth D of the groove 36 is set to about 0.45 mm, the entering amount S of the teeth roller 32 to the drive roller 31 is set to about 0.55 mm. Accordingly, the overlapping amount thereof is S-D and is to be set to about 0.1 mm. Further, pressing force F of the teeth roller 32 to the feed drive roller 31 is set by the overlapping amount Q, and the pressing force F is about 0.0784 N (8 gf). The pressing force F is not more than ¼ of the conventional pressing force F1 which is about 0.343N (35 gf) applied to the conventional feed drive roller having no groove 36. Accordingly, occurrence of scratch or the like of the contact portion in the groove 36 caused by the contact with the teeth roller 32 is reduced.

The surface layer 38 is constituted by a flexible synthetic resin material, for example, a water type polyurethane resin material and the synthetic resin material is provided by a spray coating method described below. Incidentally, the water type polyurethane material is a material by which a grip force corresponding to that of a synthetic rubber or lager than that of a synthetic rubber can be obtained without adding any wear resistance particles or the like. In addition, fabrication is easy, and a problem about environment contamination does not occur as no organic solvent is used. Further, a synthetic resin material provided by spray coating forms an even surface layer 38, so that the outer diameter size accuracy of the feed drive roller 31 is enhanced and feeding accuracy of the feed roller 1 is improved.

Teeth roller 32 is a member having a disc shape formed by a material harder than the surface layer 38, for example, a metal. A plurality of the teeth 39 are provided around the teeth roller 32. The teeth roller 32 is pivotally supported by a bar spring 35 passing through the center of the teeth roller 32. The bar spring 35 is a shaft member bridged in the direction crossing to the feeding direction of the material P to be fed, for example, in the horizontal perpendicular direction. The both ends of the bar spring 35 are rotatably supported by bearings 34, 34 provided to support frames not shown provided to the printer main body 3. Incidentally, by employing the bar spring 35 as a shaft member of the teeth roller 32, a bias force for biasing the teeth roller 32 pushed up in the upper direction by making contact with the material P to be fed at the feed drive roller 31 side to return the teeth roller 32 to the original position again can be obtained without providing any separate spring member.

### B: Movement Aspect of Feed Roller

Next, movement of the feed roller 1 will separately described when (1) the top end of a material to be fed is entered to the feed roller 1 of the invention structured in this manner and when (2) the bottom end of the material to be fed is disengaged from the feed roller.

### (1) When the Top End of a Material to be Fed is Entered (See FIGS. 5A to 5C).

Before a material P to be fed is entered in the feed roller 1, as shown in FIG. 5A, the teeth roller 32 is positioned at the lowest position and the tooth 39 positioned at the lowest end is made contact with the bottom of the groove 36 of the feed drive roller 31. Further, in this state, the tooth 39 positioned at the lowest end and one or two teeth in the vicinity thereof are simultaneously made contact with and engaged with the groove 36, and the stability of the posture of the teeth roller 32 is held.

Next, as shown in FIG. 5B, when the top end P1 of the material P to be fed begins to enter between the teeth roller 32 and the feed drive roller 31, the teeth roller 32 is held up in the upper direction by the top end P1 in some degree. Also in this state, the lowest end tooth 39 of the teeth roller 32 is positioned in the groove 36 and the front side tooth 39 to the lowest end tooth 39 is also engaged with the upper surface of the top end P1 of the material P to be fed. Accordingly, the stability of the posture of the teeth roller 32 is held.

Then, when the entrance of the material P to be fed is further proceeded, as shown in FIG. 5C, the teeth roller 32 is pushed up in the upper direction by the material P to be fed and the shape of the bar spring 35 is distorted to a convex up shape. In the state, the material P to be fed is perfectively entered between the teeth roller 32 and the feed drive roller 31, and the elastic restoring force of the bar spring 35 becomes maximum. Accordingly, the teeth 39 of the teeth roller 32 surely affect the material P to be fed, so that the stability of the posture of the teeth roller 32 is held, and the material P to be fed becomes to be stably fed in high accuracy without leaning (skewing).

(2) When the Bottom End of the Material to be Fed is Disengaged from the Feed Roller (See FIGS. 6A to 6C).

As shown in FIG. 6A, when the bottom end P2 of the material P to be fed comes close to the nip point of the teeth roller 32 and the feed drive roller 31, and as shown in FIG. 6B, the bottom end P2 of the material P to be fed reaches the state right after passing through the nip point, the teeth roller 32 is lowered in some degree by the elastic restoring force of the bar spring 35, and the lowest teeth 39 reaches inside the groove 36 and is made contact with and engaged with the groove 36. Further, the tooth 39 positioned at the rear side to the lowest tooth 39 engages the upper surface of the bottom end P2 of the paper P to be fed, so that the stability of the posture of the teeth roller 32 is held.

Further, after the material P to be fed is perfectively disengaged from the roller 1, as shown in FIG. 6C, the teeth roller 32 reaches the lowest position again by the elastic restoring force of the bar spring 35. Then, in this state, the lowest end tooth 39 of the teeth roller 32 and one or two teeth positioned in the vicinity thereof are simultaneously made contact with and engaged with the groove 36, so that the stability of the posture of the teeth roller 32 is held. Accordingly, it can be prevented that the upper surface of the top end P1 of the material P to be fed is scratched by a displacement or the like of the teeth roller 32.

### C: Manufacturing Method of Feed Drive Roller

Next, a manufacturing method of the feed drive roller 31 which is a constituent member of the feed roller 1 will be concretely described based on FIG. 7. That is, in the invention, the manufacturing method of the feed drive roller 31 is constituted by performing only two processes of (1) roller main body forming process shown in FIG. 7A and (2) surface layer forming process shown in FIG. 7B.

### (1) Roller Main Body Forming Process (See FIG. 7A)

This process is a process for forming the roller main body 37 having the groove 36 on the circumferential surface by injecting a plastic material 41 into a mold. Note that the conventional injection molding device can be used in the process, and the process is performed by correcting or adjusting the shape of a forming die 40 to the shape in which the groove 36 is formed on the circumferential surface of the roller main body 37. Further, in the embodiment show in FIG. 7A, the roller main body 37 is integrally formed with the rotation shaft 33. Then as for the plastic material 41, a material which is easy for forming and having excellent mechanical intensity is used.

### (2) Surface Layer Forming Process (See FIG. 7B)

This process is a process for forming the surface layer 38 by spraying a synthetic resin material 42 on the circumferential surface of the roller main body 37 formed by the above roller main body forming process for application and by hardening the synthetic resin material 42. As for the synthetic resin material 42, a material capable of spray application, having excellent property in grip force after solidification, and having a small thermal expansion rate can be used. In the embodiment, a water type polyurethane coating material which satisfies the conditions and does not cause environment contamination is used. Note that the film thickness T of the surface layer 38 provided by spraying the water type polyurethane coating material for application is about 20 to 25 μm. The feed drive roller 31 can be manufactured by only the two processes of the roller main body forming process and the surface layer forming process in the embodiment, so that the productivity can be improved by reducing the number of the processes. Further, by employing the spray application method, the even surface layer 38 can be provided and the accuracy of the outer diameter size of the feed drive roller 31 can be improved.

### Another Embodiment

The feed roller 1, the manufacturing method of the feed drive roller 31 which is a constituent member of the feed roller 1, and the ink jet printer 100 which is an example of the liquid ejecting apparatus in which the feed roller 1 is applied to the discharge drive roller 21 basically have the structure as described above. However, it goes without saying that modifications and omissions of a partial formation can be made without departing form the spirit of the invention.

For example, the feed roller 1 of the invention is not limited to the discharge roller 20 of the ink jet printer 100 and may be a discharge sub roller which supports the discharge roller 20. Further, the feed roller 1 can be applicable to various nip rollers used for the sake of another application except discharge as long as the feed drive roller 31 and the teeth roller 32 are equipped. Further, the application target thereof is not limited to the ink jet type printer 100 and similarly can be applied to another recording apparatus or liquid ejecting apparatus.

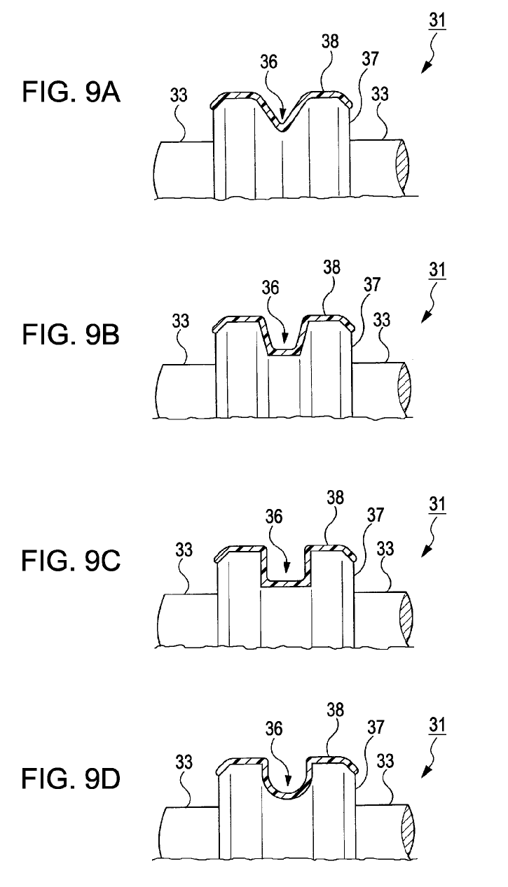

Further, the number of the groove 36 formed on the circumferential surface of the feed drive roller 31 of the feed roller 1 of the invention is not limited to one and the number may be more than one. Further, the position to which the groove 36 is provided and the width W and the depth D of the groove 36 can be appropriately changed. Further, the cross sectional shape of the groove 36 is not limited to the V character groove shape as in the above embodiment, and may have roundness at the corner of the V character groove as shown in FIG. 9A, or may be a groove shape of a reversed trapezoidal shape as shown in FIG. 9B. Alternately, the cross sectional shape of the groove 36 may be an angular groove shape as shown in FIG. 9C or may be a U character groove shape as shown in FIG. 9D.

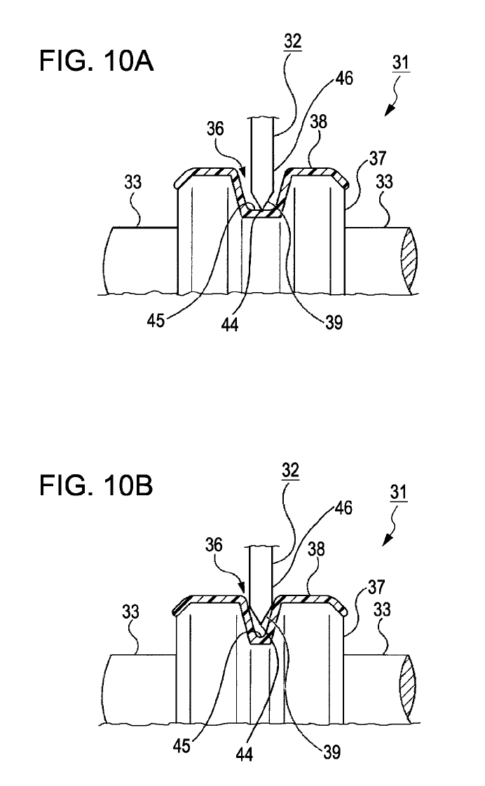

Further, as for the contact position, the distal end 44 of the tooth 39 of the teeth roller 32 may be made contact with the bottom 45 of the groove 36 as shown in FIG. 10A or the outside surface 46 of the teeth roller 32 may be made contact with the inside surface of the groove 36 by reducing the clearance of the teeth roller 32 and the groove 36 so that the distal end 44 of the tooth 39 does not make contact with the bottom 45 of the groove 36 as shown in FIG. 10B. Incidentally, when the contact structure shown in FIG. 10B is employed, the feeding accuracy of the feed roller 1 can be improved due to increasing of the binding force by the teeth roller 32 without needlessly increasing the pressing force F of the teeth roller 32 to the feed drive roller obtained by the non contact state of the distal end 44 and the bottom 45 of the groove 36.

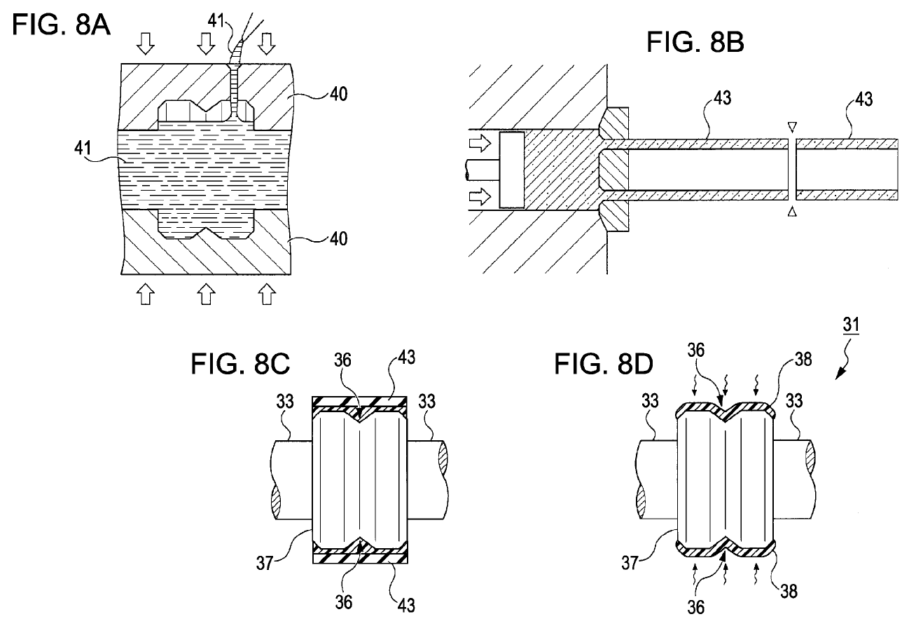

Further, the manufacturing method of the feed drive roller is not limited to the embodiment, and the constitution shown in FIGS. 8A to 8D in which the conventional equipment can be used without modification can be employed. That is, the manufacturing method of the feed drive roller shown in FIGS. 8A to 8D is constituted by three steps, a roller main body forming process, a tube member forming process, and a surface layer forming process. Then, the roller main body forming step is a step for forming the roller main body 37 having the groove 36 on the circumferential surface by injecting the plastic material 41 into a mold, and is the same process as the roller main body forming process shown in FIG. 7A. The tube member forming process is a process for forming the long tube member 43 having heat shrink property and dividing the tube member 43 into the length of the roller main body 37. Further, the surface layer forming process is a process for forming the surface layer 38 having a shape fitted to the roller main body 37 by covering the tube member 43 on the formed roller main body 37 and by heating the tube member 43 for thermal contraction. Incidentally, according the embodiment, the feed drive roller 31 having an excellent feeding accuracy can be manufactured without new equipment investment.

What is claimed is:

1. A feed roller comprising:
a feed drive roller; and
a teeth roller drivenly rotated by making contact with the feed drive roller, wherein
the circumferential surface of the feed drive roller is equipped with a groove with which a part of the teeth roller makes contact.

2. The feed roller according to claim 1, wherein the feed drive roller is equipped with a roller main body having the groove on the circumferential surface, and a surface layer for covering the roller main body so that the groove appears on the circumferential surface.

3. The feed roller according to claim 2, wherein the surface layer is a flexible synthetic resin material.

4. The feed roller according to claim 3, wherein the flexible synthetic resin material is applied by spray.

5. The feed roller according to claim 3, wherein the flexible synthetic resin material is a water type polyurethane resin material.

6. The feed roller according to claim 1, wherein not less than two teeth of teeth of the teeth roller are entered in and made contact with the groove in the state where no material to be fed is present between the feed drive roller and the teeth roller.

7. The feed roller according to claim 1, wherein the teeth roller is pivotally supported by a bar spring bridged in the direction crossing a feeding direction of a material to be fed.

8. The feed roller according to claim 1, wherein the cross sectional shape of the groove is a V character groove shape.

9. The feed roller according to claim 1, wherein the width size of the groove is set so that the outside surface of the teeth roller is made contact with the inside surface of the groove.

10. The feed roller according to claim 9, wherein the distal end of the teeth roller makes no contact with the circumferential surface of the feed drive roller.

11. A manufacturing method of a feed drive roller, comprising:
forming a roller main body having a groove receiving a part of a teeth roller and making contact with a part of the teeth roller on the circumferential surface by injecting a plastic material into a mold; and
forming a surface layer by spraying a synthesis resin coating material on the circumferential surface of the formed roller main body for application and by hardening the synthesis resin coating material.

12. A recording apparatus comprising:
a recording unit for performing recording by ejecting an ink from a recording head in the state where a material to be recorded is supported by a platen; and
a discharge roller for discharging a material to be recorded on which record is performed to the outside, wherein
the discharge roller is equipped with a discharge drive roller and a teeth roller drivenly rotated by making contact with the discharge drive roller, and
the circumferential surface of the discharge drive roller is equipped with a groove with which at least a part of the teeth roller makes contact.
